(19) United States
(12) Patent Application Publication
(10) Pub. No.: US 2025/0138390 A1
(43) Pub. Date: May 1, 2025

(54) OPTICAL MEMBER DRIVING MECHANISM

(71) Applicant: TDK TAIWAN CORP., Taoyuan City (TW)

(72) Inventors: Shi Xuan LIN, Taoyuan City (TW); Wei-Jhe SHEN, Taoyuan City (TW); Kun-Shih LIN, Taoyuan City (TW)

(21) Appl. No.: 18/925,372

(22) Filed: Oct. 24, 2024

Related U.S. Application Data
(60) Provisional application No. 63/593,347, filed on Oct. 26, 2023.

(51) Int. Cl. G03B 5/00

(52) U.S. Cl. CPC G03B 5/00; G03B 2205/0007; G03B 2205/0069

(57) ABSTRACT

An optical member driving mechanism is provided. The optical member driving mechanism includes a movable portion, a fixed portion, and a driving assembly. The movable portion is configured to connect an optical member, and is movable relative to the fixed portion. The driving assembly is configured to drive the movable portion to move relative to the fixed portion.

### CROSS REFERENCE TO RELATED APPLICATIONS

This application claims the benefit of U.S. Provisional Application No. 63/593,347, filed Oct. 26, 2023, the entirety of which is incorporated by reference herein.

### BACKGROUND OF THE INVENTION

### Field of the Invention

The application relates in general to an optical member driving mechanism, and in particular it relates to an optical member driving mechanism for driving an optical member to move.

### Description of the Related Art

As technology has advanced, a lot of electronic devices (for example, tablet computers and smartphones) have been given the functionality of taking photographs and recording video. These electronic devices have become more commonplace, and have been developed to be more convenient and thin. More and more choices are provided for users to choose from.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move relative to the fixed portion.

In some embodiments, as observed along the main axis, the fixed portion includes a polygonal profile, and the polygonal profile includes a first side and a second side. The first side extends along a first axis, and the second side extends along a second axis. The first axis is not parallel to the second axis. The largest dimensions of the first side along the first axis are different than the largest dimensions of the second side along the second axis. The driving assembly is situated at the first side.

In some embodiments, the driving assembly includes a coil, a first magnetic member, and a second magnetic member. The first magnetic member corresponds to the coil, and the second magnetic member is adjacent to the first magnetic member. The first magnetic member has a first surface and a second surface, the first surface faces the coil and is perpendicular to a third axis, the second surface faces the second magnetic member is perpendicular to a fourth axis. The second magnetic member has a third surface facing the first magnetic member, and the third surface is perpendicular to the fourth axis. As observed along the fourth axis, at least a portion of the second surface does not overlap the third surface.

In some embodiments, the second magnetic member further has a fourth surface and a fifth surface, the fourth surface and the fifth surface are parallel to the fourth axis, the fourth surface is not parallel to the fifth surface, and the fourth surface is not perpendicular to the fifth surface.

In some embodiments, as observed along the fourth axis, the first magnetic member has a longitudinal structure, and in the longitudinal direction of the longitudinal structure, the largest dimensions of the first magnetic member are different than the largest dimensions of the second magnetic member.

In some embodiments, the fixed portion includes a housing, the housing has a top wall, and the distance between the second magnetic member and the top wall is less than the distance between the first magnetic member and the top wall. A first depression portion is formed on the top wall, and the first depression portion does not overlap the second magnetic member as observed along the fourth axis. As observed along the fourth axis, the first depression overlaps the first magnetic member.

In some embodiments, the housing further comprises a second depression portion corresponding to the second magnetic member. As observed along the main axis, the second depression portion is situated at the first side, the second depression portion overlaps the second magnetic member, the first depression portion is situated at a corner of the fixed portion, the first depression portion is situated at the first side, and the first depression portion is adjacent to the second depression portion. The first depression portion has a first depression portion surface facing the first magnetic member, and a gap which is greater than zero is formed between the first depression surface and the first magnetic member.

In some embodiments, the housing further has a lateral wall connected to the top wall, the optical member driving mechanism further includes a connecting member, and the first magnetic member is connected to the lateral wall via the connecting member. The second depression portion has a second depression surface facing the second magnetic member, and the connecting member is in direct contact with the second depression surface. The first depression surface is connected to the lateral surface. The second magnetic member is connected to the lateral surface via the connecting member.

In some embodiments, as observed along the fourth axis, the largest dimensions of the first magnetic member along the third axis are the same as the largest dimensions of the second magnetic member along the third axis, and both the first magnetic member and the second magnetic member are disposed at the first side.

In some embodiments, the optical member driving mechanism further includes an anti-vibration assembly configured to restrain a vibration of the movable portion, and the anti-vibration assembly includes a first disposing portion and an anti-vibration member. The first disposing portion is disposed on the movable portion, wherein as observed along a fifth axis, the first disposing portion extends along an extending direction and protrudes from the movable portion. The anti-vibration member is disposed on a first lateral surface of the first disposing portion. The first lateral surface is not perpendicular to the extending direction as observed along the fifth axis. The first disposing portion further includes a second lateral surface, and the second lateral surface is adjacent to first lateral surface and is not parallel to the first lateral surface. The first disposing portion further includes a third lateral surface, and the third lateral surface is adjacent to second lateral surface and is not parallel to the second lateral surface. As observed along the fifth axis, the first lateral surface and the third lateral surface are respectively disposed on opposite sides of the first disposing portion. The anti-vibration member is not in contact with the third lateral surface. The first lateral surface and the third lateral surface are parallel to each other.

In some embodiments, the anti-vibration member further includes a second disposing portion, the second disposing portion is disposed on the fixed portion and has a fourth lateral surface, and the anti-vibration member is in direct contact with the fourth lateral surface. The fourth lateral surface faces the first lateral surface. The first disposing portion and the second disposing portion are movable relative each other. As observed along the fifth axis, the fourth lateral surface is not perpendicular to the extending direction. The second disposing portion further includes a fifth lateral surface, and the fourth lateral surface and the fifth lateral surface are disposed on opposite sides of the second disposing portion as observed along the fifth axis.

In some embodiments, the third axis is parallel to the second axis.

In some embodiments, the optical member driving mechanism further includes an elastic member, and the elastic member includes a movable portion fixing section, a fixed portion fixing section, and a string section. The movable portion fixing section is affixed to the movable portion. The fixed portion fixing section is affixed to the fixed portion. The string section is connected to the movable portion fixing section and the fixed portion fixing section, wherein the fixing portion fixing section is situated at the second side.

In some embodiments, the fixed portion includes a housing and a base, the housing includes a lateral wall, the base includes a lateral pillar, and the lateral wall and the lateral pillar are connected to each other, wherein the movable portion includes a winding pillar, an end of the coil winds around the winding pillar, an opening is formed on the lateral pillar, and the winding pillar is accommodated in the opening.

In some embodiments, the fixed portion includes a base, the base includes a bottom plate and a lateral pillar connected to the bottom plate, and a through hole is formed on the lateral pillar, wherein the optical member driving mechanism further comprises a sensor, and the sensor is accommodated in the through hole.

In some embodiments, the fixed portion includes a base, the base includes a bottom plate and a lateral pillar connected to the bottom plate, and a depression structure is formed on a surface of the lateral pillar facing away from the movable portion, wherein the optical member driving mechanism further comprises a sensor, and the sensor is disposed on the lateral pillar and disposed in the depression structure.

In some embodiments, the fixed portion includes a base, the base includes a bottom plate and a lateral pillar connected to the bottom plate, and a hole is formed on the bottom plate, wherein the optical member driving mechanism further comprises a sensor, and the sensor is accommodated in the hole.

### BRIEF DESCRIPTION OF DRAWINGS

The invention can be more fully understood by reading the subsequent detailed description and examples with references made to the accompanying drawings, wherein:

FIG. 1 is a schematic diagram of an electronic device having an optical member driving mechanism according to an embodiment of the invention;

FIG. 2 is a schematic diagram of the optical member driving mechanism according to an embodiment of the invention;

FIG. 3 is an exploded-view diagram of the optical member driving mechanism according to an embodiment of the invention;

FIG. 4A is a schematic diagram of an elastic member according to an embodiment of the invention;

FIG. 4B is a schematic diagram of another elastic member according to an embodiment of the invention;

FIG. 5 is a cross-sectional view taken along the line A-A in FIG. 2;

FIG. 6 is a cross-sectional view taken along the line B-B in FIG. 2;

FIG. 7 is a cross-sectional view taken along the line C-C in FIG. 2;

FIG. 8 is a schematic diagram of a base and a sensing assembly according to another embodiment of the invention; and

FIG. 9 is a schematic diagram of a base and a sensing assembly according to another embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

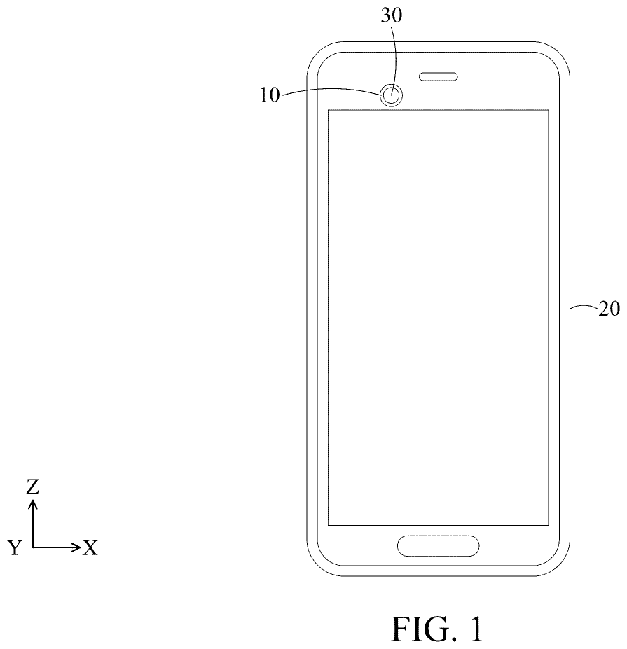

Referring to FIG. 1, an optical member driving mechanism 10 according to an embodiment of the invention can be disposed in an electronic device 20. The optical member driving mechanism 10 can be configured to hold and drive an optical member 30, so that the optical member 30 can move relative to an image sensor (not shown) in the electronic device 20, and the purpose of focusing, zooming, and/or optical image stabilization (OIS) can be achieved. For example, the electronic device 20 can be a smartphone, a tablet computer, or a digital camera, and the optical member 30 can be a camera lens with a plurality of lenses, but it is not limited thereto.

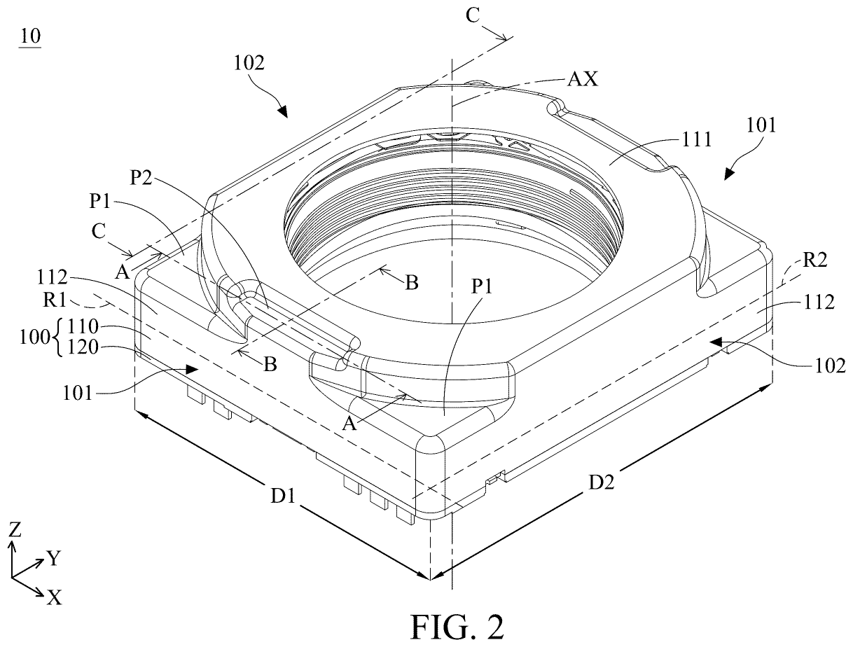

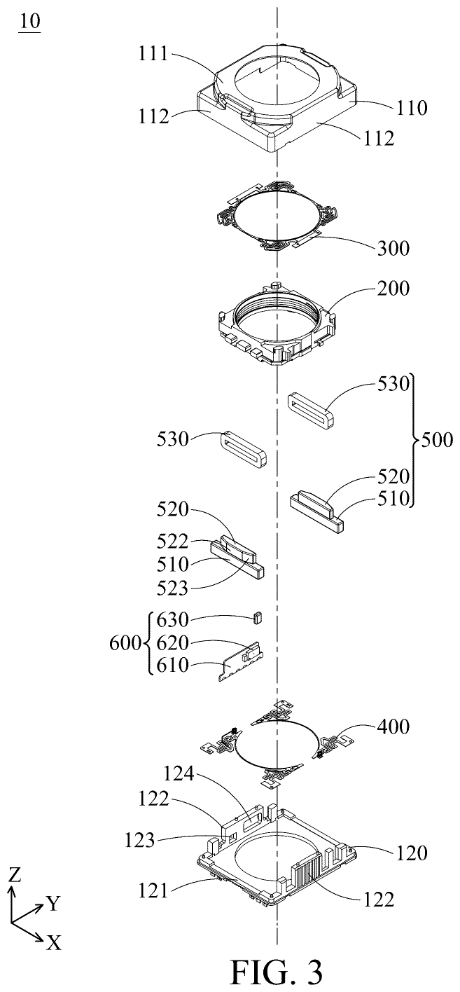

FIG. 2 is a schematic diagram of the optical member driving mechanism 10, and FIG. 3 is an exploded-view diagram of the optical member driving mechanism 10. As shown in FIG. 2 and FIG. 3, the optical member driving mechanism 10 primarily includes a fixed portion 100, a movable portion 200, an elastic member 300, an elastic member 400, a driving assembly 500, and a sensing assembly 600.

The fixed portion 100 includes a housing 110 and a base 120. The housing 110 and a base 120 can be engaged with each other to form a hollow box. The movable portion 200, the elastic member 300, the elastic member 400, the driving assembly 500, and the sensing assembly 600 can be accommodated in the hollow box, so as to protect the aforementioned members.

As observed from the main axis AX of the optical member driving mechanism 10 (i.e. the optical axis of the optical member 30), the fixed portion 100 substantially includes a polygonal profile (such as a rectangular profile), and the polygonal profile includes a first side 101 and a second side 102. The first side 101 extends along a first axis R1, the second side 102 extends along a second axis R2, and the first axis R1 is not parallel to the second axis R2. The largest dimensions D1 of the first side 101 along the first axis R1 are different from the largest dimensions D2 of the second side 102 along the second axis R2. In this embodiment, the first axis R1 and the second axis R2 are perpendicular to each other, and the largest dimensions D1 of the first side 101 along the first axis R1 is less than the largest dimensions D2 of the second side 102 along the second axis R2

The housing 110 of the fixed portion 100 includes a top wall 111 and a plurality of lateral walls 112. The lateral walls 112 are connected to the top wall 111 and extended toward the base 120. On the top wall 111, at least one first depression portion P1 and at least one second depression portion P2 are formed thereon. The first depression portion P1 and the second depression portion P2 are adjacent to each other, and both of them are situated at the first side 101. As observed along the main axis AX, the first depression portion P1 is located at the corner of the polygonal profile, and the second depression portion P2 is located between the corners of the polygonal profile.

The base 120 of the fixed portion 100 includes a bottom plate 121 and a plurality of lateral pillars 122. The lateral pillars 122 are connected to the bottom plate 121 and extended toward the top wall 111 of the housing 110. When the fixed portion 100 is to be assembled, the user can use an adhesive member (such as a glue or a tape) to adhere the lateral walls 112 and the lateral pillars 122, and the housing 110 and the base 120 can be affixed to each other.

The movable portion 200 is configured to connect the optical member 30, and is movably connected to the fixed portion 100. In detail, the movable portion 200 is accommodated in the hollow box in a suspension manner through the elastic member 300 and the elastic member 400.

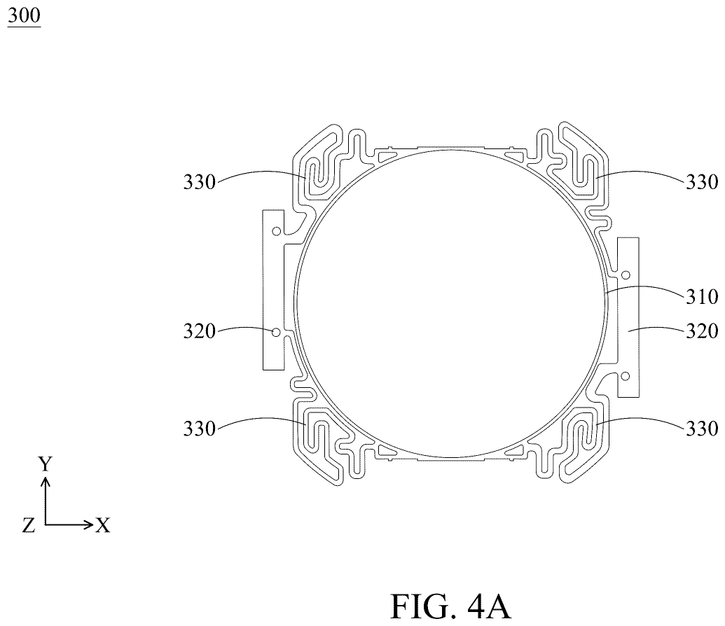

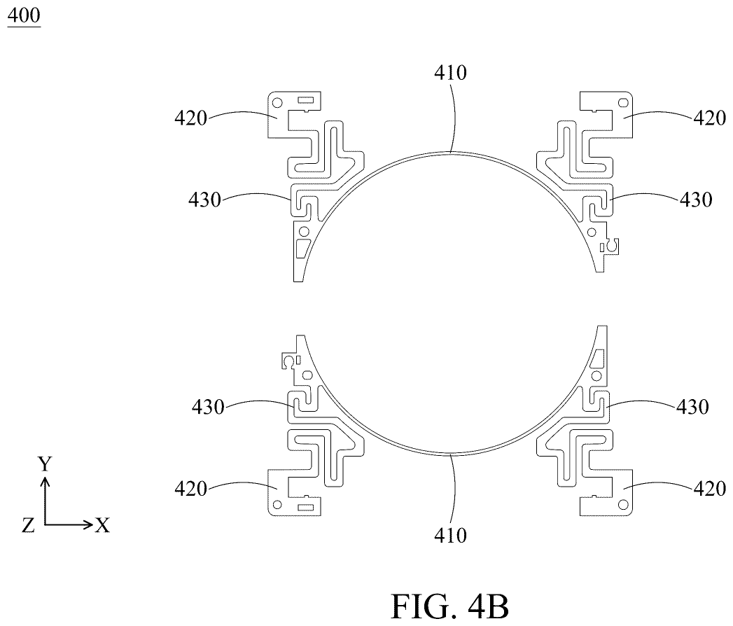

As shown in FIG. 4A, the elastic member 300 includes at least one movable portion fixing section 310, at least one fixed portion fixing section 320, and at least one string section 330. The movable portion fixing section 310 is affixed to the upper surface of the movable portion 200, the fixed portion fixing section 320 is affixed to the fixed portion 100 (for example, it can be affixed to the lateral pillars 122), and the string section 330 can be disposed between the movable portion fixing section 310 and the fixed portion fixing section 320 to connect them.

As shown in FIG. 4B, similarly, the elastic member 400 includes at least one movable portion fixing section 410, at least one fixed portion fixing section 420, and at least one string section 430. The movable portion fixing section 410 is affixed to the lower surface of the movable portion 200, the fixed portion fixing section 420 is affixed to the fixed portion 100 (for example, it can be affixed to the bottom plate 121), and the string section 430 can be disposed between the movable portion fixing section 410 and the fixed portion fixing section 420 to connect them.

In particular, in this embodiment, the fixed portion fixing section 320 of the elastic member 300 and the fixed portion fixing section 420 of the elastic member 400 are situated at the second side 102 (i.e. the long side of the optical member driving mechanism 10), and are not situated at the first side 101 (i.e. the short side of the optical member driving mechanism 10).

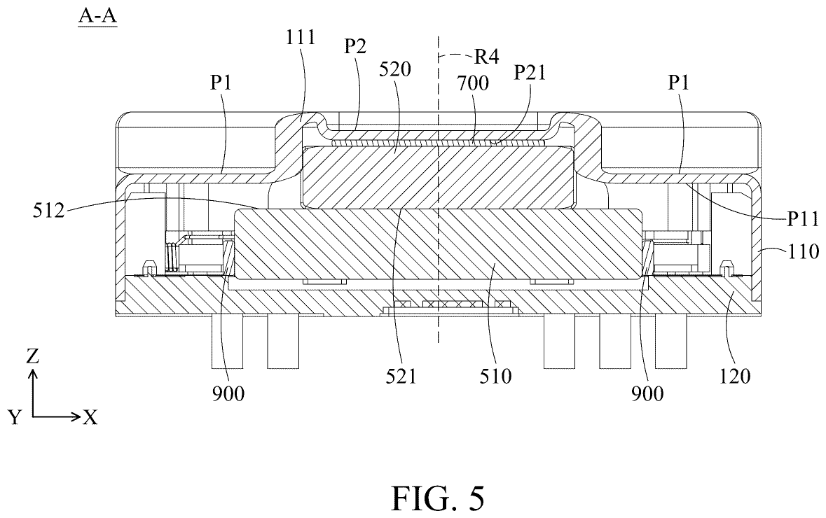

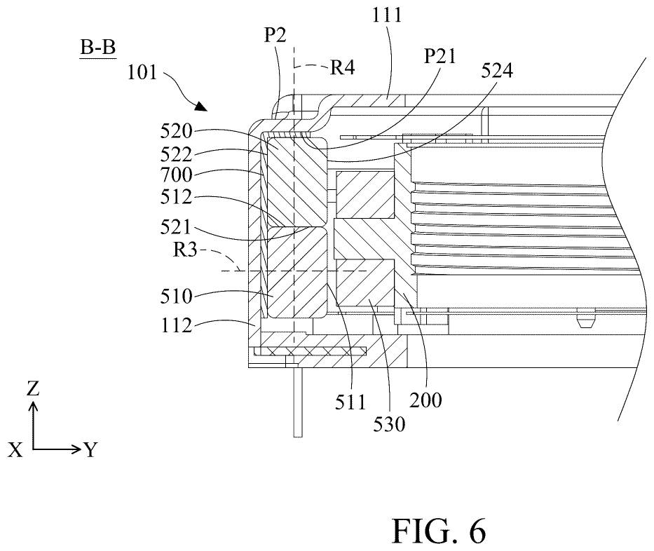

FIG. 5 is a cross-sectional view taken along the line A-A in FIG. 2, and FIG. 6 is a cross-sectional view taken along the line B-B in FIG. 2. As shown in FIGS. 2-3 and 5-6, the driving assembly 500 includes at least one first magnetic member 510, at least one second magnetic member 520, and at least one coil 530.

The first magnetic member 510 and the second magnetic member 520 are stacked along the main axis AX at the first side 101, the coil 530 is disposed on the movable portion 200, and the positions of the first magnetic member 510 and the second magnetic member 520 correspond to the position of the coil 530. The first magnetic member 510 substantially has a cuboid structure, and includes a first surface 511 and a second surface 512. The first surface 511 faces the coil 530 and is perpendicular to a third axis R3. The second surface 512 faces the second magnetic member 520 and is perpendicular to a fourth axis R4. In this embodiment, the first surface 511 and the second surface 512 are connected to each other and are perpendicular to each other, so that the third axis R3 is perpendicular to the fourth axis R4. Moreover, in this embodiment, the fourth axis R4 is parallel to the main axis AX of the optical member driving mechanism 10.

As shown in FIG. 5, the first depression portion P1 has a first depression surface P11 that is connected to the lateral wall 112 and faces the first magnetic member 510. When the first magnetic member 510 is disposed in the hollow box of the fixed portion 100, the first depression surface P11 overlaps the first magnetic member 510 as observed along the fourth axis R4. It should be noted that, the first depression surface P11 is not in contact with the first magnetic member 510. In other words, a gap greater than zero is formed between the first depression surface P11 and the first magnetic member 510.

The second magnetic member 520 is adjacent to the first magnetic member 510 and disposed between the first magnetic member and the top wall 111 of the housing 110. Therefore, the distance between the second magnetic member 520 and the top wall 111 is less than the distance between the first magnetic member 510 and the top wall 111. The appearance of the second magnetic member 520 fits the first depression portion P1, so that the first depression portion P1 does not overlap the second magnetic member 520 as observed along the fourth axis R4.

The second magnetic member 520 includes a third surface 521, a fourth surface 522, and a fifth surface 523. The third surface 521 faces the first magnetic member 510 and is perpendicular to the fourth axis R4. The fourth surface 522 and the fifth surface 523 are connected to each other and parallel to the fourth axis R4. Specifically, an acute angle is formed between the fourth surface 522 and the fifth surface 523, so that the fourth surface 522 and the fifth surface 523 are not parallel and are not perpendicular.

In this embodiment, as observed along the fourth axis R4, the first magnetic member 510 substantially has a longitudinal structure, and the second magnetic member 520 substantially has a trapezoid structure. In the longitudinal direction of the longitudinal structure of the first magnetic member 510, the largest dimensions of the first magnetic member 510 are greater than the largest dimensions of the second magnetic member 520. Therefore, at least a portion of the second surface 512 does not overlap the third surface 521.

The position of the second depression portion P2 corresponds to the position of the second magnetic member 520. Therefore, as observed along the fourth axis R4, the second depression portion P2 overlaps the second magnetic member 520.

When the first magnetic member 510 and the second magnetic member 520 are mounted on the fixed portion 100, they can use a connecting member 700 to affix. For example, the connecting member 700 can be disposed between the first magnetic member 510 and the lateral walls 112 of the housing 110 and between the second magnetic member 520 and the lateral walls 112 of the housing 110, and in contact with the first magnetic member 510, the second magnetic member 520 and the lateral walls 112, so as to affix the first magnetic member 510 and the second magnetic member 520 to the lateral walls 112. In this embodiment, the connecting member 700 can be further extended to a position between the second magnetic member 500 and a second depression surface P21 of the second depression portion P2 (the second depression surface P21 is a surface of the second depression portion P2 facing the second magnetic member 520), and in contact with the second magnetic member 520 and the second depression surface P21, so as to affix the first magnetic member 510 and the second magnetic member 520 to the housing 110 more steadily. In this embodiment, the first magnetic member 510 is further affixed to the base 120 of the fixed portion 100 via a connecting member 900. The connecting member 900 is disposed on the lateral side of the first magnetic member 510, and is in contact with the first magnetic member and the base 120.

Each of the connecting member 700 and the connecting member 900 can be a glue or a tape, but it is not limited thereto. For example, in this embodiment, the connecting member 700 is a thermal curing glue, and the connecting member 900 is a thermal curing and light curing glue.

When current flows through the coil 530, the electromagnetic effect between the coil 530 and the first magnetic member 510 and the electromagnetic effect between the coil 530 and the second magnetic member 520 can provide a driving force to the movable portion 200 to move the movable portion 200 and the optical member 300 thereon along the main axis AX relative to the fixed portion 100. Thus, the purpose of zooming and/or focusing can be achieved.

As shown in FIG. 6, in this embodiment, the largest dimensions of the first magnetic member 510 along the third axis R3 are substantially the same as the largest dimensions of the second magnetic member 520 along the third axis R3, so that the driving assembly 500 can provide the uniform driving force to the movable portion 200. The magnetic pole on the sixth surface 524 of the second magnetic member 520 facing the coil 530 can be opposite to the magnetic pole on the first surface 511 of the first magnetic member 510, so as to enhance the driving force of the driving assembly 500.

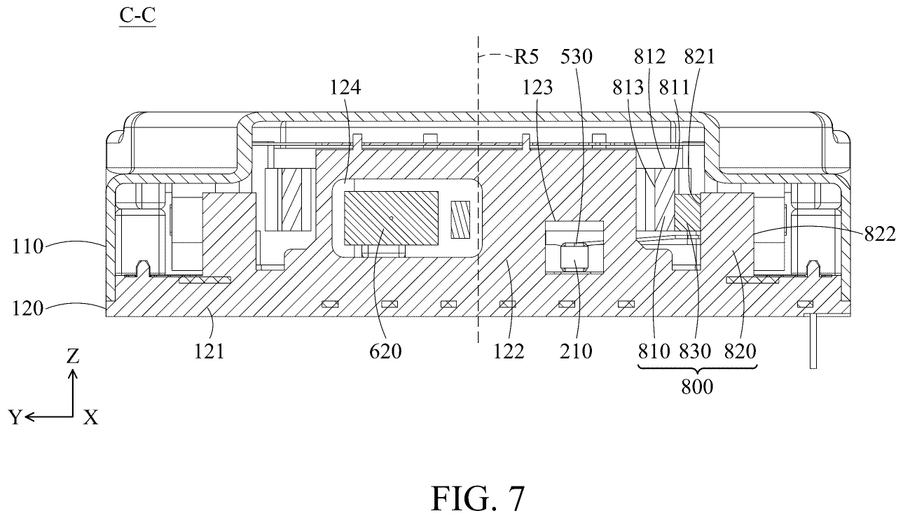

FIG. 7 is a cross-sectional view taken along the line C-C in FIG. 2. As shown in FIG. 7, in this embodiment, an end of the coil 530 can wind around a winding pillar 210 of the movable portion 200, and an opening 123 corresponding to the winding pillar 210 can be formed on the lateral pillars 122 of the base 120. The wining pillar 210 is accommodated in the opening 123, so as to facilitate the miniaturization of the optical member driving mechanism 10.

Moreover, as shown in FIG. 7, in this embodiment, the optical member driving mechanism 10 can further include an anti-vibration assembly 800. The anti-vibration assembly 800 can include at least one disposing portion 810, at least one second disposing portion 820, and at least one anti-vibration member 830.

The first disposing portion 810 is connected to the movable portion 200. As observed along the fifth axis R5, the first disposing portion 810 extends along an extending direction (the X-axis in the figures) and protrudes from the movable portion 200. The first disposing portion 810 has a first lateral surface 811, a second lateral surface 812, and a third lateral surface 813. The first lateral surface 811 is not perpendicular to the extending direction. The second lateral surface 812 is adjacent to the first lateral surface 811 and is not parallel to the first lateral surface 811. The third lateral surface 813 is adjacent to the second lateral surface 812 and is not parallel to the second lateral surface 812. As observed along the fifth axis R5, the first lateral surface 811 and the third lateral surface 813 are respectively disposed on the opposite sides of the first disposing portion 810, and the first lateral surface 811 and the third lateral surface 813 are parallel to each other. The first disposing portion 810 and the movable portion 200 can be integrally formed as one piece, but it is not limited thereto.

The second disposing portion 820 is connected to the base 120, and has a fourth lateral surface 821 and a fifth lateral surface 822. The fourth lateral surface 821 faces the first lateral surface 811. As observed along the fifth axis R5, the fourth lateral surface 821 is not perpendicular to the extending direction of the first disposing portion 810, and the fourth lateral surface 821 and the fifth lateral surface 822 are respectively disposed on the opposite sides of the second disposing portion 820. Since the first disposing portion 810 and the second disposing portion 820 are respectively disposed on the movable portion 200 and the fixed portion 100, when the movable portion 200 moves relative to the fixed portion 100, the first disposing portion 810 also moves relative to the second disposing portion 820. The second disposing portion 820 and the base 120 of the fixed portion 100 can be integrally formed as one piece, but it is not limited thereto.

The anti-vibration member 830 is disposed between the first disposing portion 810 and the second disposing portion 820 and in contact with the first lateral surface 811 of the first disposing portion 810 and the fourth lateral surface 821 of the second disposing portion 820. For example, the anti-vibration member 830 can include gel, therefore, the anti-vibration member 830 can reduce the vibration during movement of the movable portion 200 relative to the fixed portion 100. In this embodiment, the anti-vibration member 830 is not in contact with the second lateral surface 812, the third lateral surface 813, and the fifth lateral surface 822, so that it does not influence the movement of the movable portion 200.

Referring to FIG. 3 and FIG. 7, the sensing assembly 600 includes a circuit board 610, a sensor 620, and a sensing object 630. The circuit board 610 is disposed on the lateral pillars 122 of the base 120, the sensor 620 is disposed on the circuit board 610, and the sensing object 630 is disposed on the movable portion 200 and corresponds to the sensor 620. The sensor 620 can detect the movement of the sensing object 630 to obtain the displacement of the movable portion 200 relative to the fixed portion 100.

For example, the sensor 620 can be a Hall sensor, a magnetoresistance effect sensor (MR sensor), a giant magnetoresistance effect sensor (GMR sensor), a tunneling magnetoresistance effect sensor (TMR sensor), or a fluxgate sensor, and the sensing object 630 can be a magnet, but it is not limited thereto.

In this embodiment, a through hole 124 can be formed on the lateral pillars 122, and the sensor 620 can be accommodated in the through hole 124. Therefore, the miniaturization of the optical member driving mechanism 10 can be facilitated, and the sensing accuracy of the sensing assembly 600 can be enhanced.

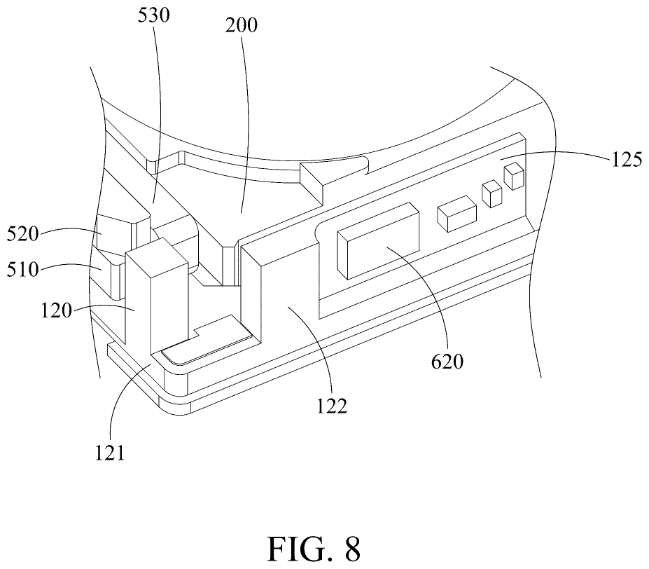

Referring to FIG. 8, in another embodiment of the invention, the sensing assembly 600 can omit the circuit board 610, and a depression structure 125 can be formed on the surface of the lateral pillars 122 facing away from the movable portion 200. The sensor 620 can be accommodated in the depression structure 125, and can be affixed to the lateral pillars 122 and electrically connected to the circuit embedded in the base 120 by a suitable method (for example, by SMT (surface-mount technology)). Therefore, the optical member driving mechanism 10 can be further miniaturized.

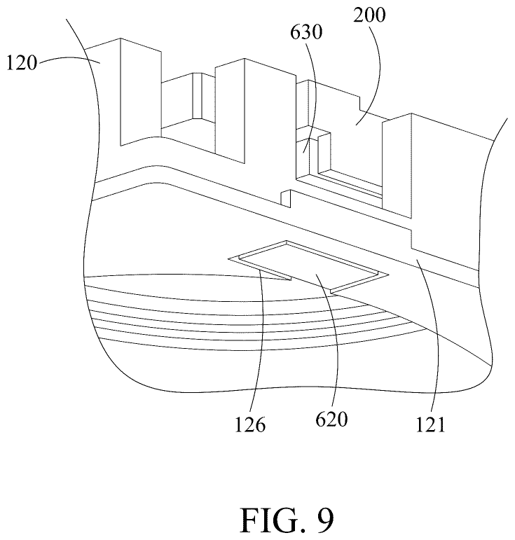

Referring to FIG. 9, in another embodiment of the invention, the sensing assembly 600 can omit the circuit board 610, and a hole 126 can be formed on the bottom plate 121 of the fixed portion 100. The sensor 620 can be accommodated in the hole 126, and can be affixed to the bottom plate 121 and electrically connected to the circuit embedded in the base 120 by a suitable method (for example, by SMT). Therefore, the optical member driving mechanism 10 can be further miniaturized.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move relative to the fixed portion.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move relative to the fixed portion.

2. The optical member driving mechanism as claimed in claim 1, wherein as observed along a main axis, the fixed portion comprises a polygonal profile, and the polygonal profile comprises:
a first side, extending along a first axis; and
a second side, extending along a second axis,
wherein the first axis is not parallel to the second axis,
largest dimensions of the first side along the first axis are different from largest dimensions of the second side along the second axis, and
the driving assembly is situated at the first side.

3. The optical member driving mechanism as claimed in claim 2, wherein the driving assembly comprises:
a coil;
a first magnetic member, corresponding to the coil; and
a second magnetic member, adjacent to the first magnetic member,
wherein the first magnetic member has a first surface facing the coil, and the first surface is perpendicular to a third axis,
the first magnetic member further has a second surface facing the second magnetic member, and the second surface is perpendicular to a fourth axis,
the second magnetic member has a third surface facing the first magnetic member, and the third surface is perpendicular to the fourth axis, and
as observed along the fourth axis, at least a portion of the second surface does not overlap the third surface.

4. The optical member driving mechanism as claimed in claim 3, wherein the second magnetic member further has a fourth surface and a fifth surface, the fourth surface and the fifth surface are parallel to the fourth axis, the fourth surface is not parallel to the fifth surface, and the fourth surface is not perpendicular to the fifth surface.

5. The optical member driving mechanism as claimed in claim 3, wherein as observed along the fourth axis, the first magnetic member has a longitudinal structure, and in a longitudinal direction of the longitudinal structure, largest dimensions of the first magnetic member are different from largest dimensions of the second magnetic member.

6. The optical member driving mechanism as claimed in claim 3, wherein the fixed portion comprises a housing, the housing has a top wall, and a distance between the second magnetic member and the top wall is less than a distance between the first magnetic member and the top wall,
a first depression portion is formed on the top wall, and the first depression portion does not overlap the second magnetic member as observed along the fourth axis, and
as observed along the fourth axis, the first depression overlaps the first magnetic member.

7. The optical member driving mechanism as claimed in claim 6, wherein the housing further comprises a second depression portion corresponding to the second magnetic member,
as observed along the main axis, the second depression portion is situated at the first side,
as observed along the main axis, the second depression portion overlaps the second magnetic member,
as observed along the main axis, the first depression portion is situated at a corner of the fixed portion,
as observed along the main axis, the first depression portion is situated at the first side,
as observed along the main axis, the first depression portion is adjacent to the second depression portion,
the first depression portion has a first depression portion surface facing the first magnetic member, and
a gap which is greater than zero is formed between the first depression surface and the first magnetic member.

8. The optical member driving mechanism as claimed in claim 7, wherein the housing further has a lateral wall connected to the top wall, the optical member driving mechanism further comprises a connecting member, and the first magnetic member is connected to the lateral wall via the connecting member,
the second depression portion has a second depression surface facing the second magnetic member, and the connecting member is in direct contact with the second depression surface,
the first depression surface is connected to the lateral surface,
the second magnetic member is connected to the lateral surface via the connecting member.

9. The optical member driving mechanism as claimed in claim 3, wherein as observed along the fourth axis, largest dimensions of the first magnetic member along the third axis are the same as largest dimensions of the second magnetic member along the third axis, and both the first magnetic member and the second magnetic member are disposed at the first side.

10. The optical member driving mechanism as claimed in claim 3, wherein the optical member driving mechanism further comprises an anti-vibration assembly configured to restrain a vibration of the movable portion, and the anti-vibration assembly comprises:
a first disposing portion, disposed on the movable portion, wherein as observed along a fifth axis, the first disposing portion extends along an extending direction and protrudes from the movable portion; and
an anti-vibration member, disposed on a first lateral surface of the first disposing portion,
wherein the first lateral surface is not perpendicular to the extending direction as observed along the fifth axis,
the first disposing portion further comprises a second lateral surface, and the second lateral surface is adjacent to first lateral surface and is not parallel to the first lateral surface,
the first disposing portion further comprises a third lateral surface, and the third lateral surface is adjacent to second lateral surface and is not parallel to the second lateral surface,
as observed along the fifth axis, the first lateral surface and the third lateral surface are respectively disposed on opposite sides of the first disposing portion,
the anti-vibration member is not in contact with the third lateral surface, and
the first lateral surface and the third lateral surface are parallel to each other.

11. The optical member driving mechanism as claimed in claim 10, wherein the anti-vibration member further comprises a second disposing portion, the second disposing portion is disposed on the fixed portion and has a fourth lateral surface, and the anti-vibration member is in direct contact with the fourth lateral surface,
the fourth lateral surface faces the first lateral surface,
the first disposing portion and the second disposing portion are movable relative each other,
as observed along the fifth axis, the fourth lateral surface is not perpendicular to the extending direction, and
the second disposing portion further comprises a fifth lateral surface, wherein the fourth lateral surface and the fifth lateral surface are disposed on opposite sides of the second disposing portion as observed along the fifth axis.

12. The optical member driving mechanism as claimed in claim 3, wherein the third axis is parallel to the second axis.

13. The optical member driving mechanism as claimed in claim 3, wherein the optical member driving mechanism further comprises an elastic member, and the elastic member comprises:
a movable portion fixing section, affixed to the movable portion;
a fixed portion fixing section, affixed to the fixed portion; and
a string section, connected to the movable portion fixing section and the fixed portion fixing section, wherein the fixing portion fixing section is situated at the second side.

14. The optical member driving mechanism as claimed in claim 3, wherein the fixed portion comprises a housing and a base, the housing comprises a lateral wall, the base comprises a lateral pillar, and the lateral wall and the lateral pillar are connected to each other, wherein the movable portion comprises a winding pillar, an end of the coil winds around the winding pillar, an opening is formed on the lateral pillar, and the winding pillar is accommodated in the opening.

15. The optical member driving mechanism as claimed in claim 3, wherein the fixed portion comprises a base, the base comprises a bottom plate and a lateral pillar connected to the bottom plate, and a through hole is formed on the lateral pillar, wherein the optical member driving mechanism further comprises a sensor, and the sensor is accommodated in the through hole.

16. The optical member driving mechanism as claimed in claim 3, wherein the fixed portion comprises a base, the base comprises a bottom plate and a lateral pillar connected to the bottom plate, and a depression structure is formed on a surface of the lateral pillar facing away from the movable portion, wherein the optical member driving mechanism further comprises a sensor, and the sensor is disposed on the lateral pillar and disposed in the depression structure.

17. The optical member driving mechanism as claimed in claim 3, wherein the fixed portion comprises a base, the base comprises a bottom plate and a lateral pillar connected to the bottom plate, and a hole is formed on the bottom plate, wherein the optical member driving mechanism further comprises a sensor, and the sensor is accommodated in the hole.
